(19) United States
(12) Patent Application Publication
(10) Pub. No.: US 2025/0199894 A1
(43) Pub. Date: Jun. 19, 2025

(54) METHOD AND SYSTEM FOR PREDICTING SERVER HARDWARE AND SERVER HARDWARE COMPONENT FAILURES

(71) Applicant: JPMorgan Chase Bank, N.A., New York, NY (US)

(72) Inventors: Rajat RAY, Singapore (SG); Pamela Hui SIN, Singapore (SG); Victoria ZANATIAN, Columbus, OH (US); Navin VARMA, Hyderabad (IN); De Hui Adrian TAN, Singapore (SG); Gui Kang OW YONG, Singapore (SG)

(73) Assignee: JPMorgan Chase Bank, N.A., New York, NY (US)

(21) Appl. No.: 18/427,290

(22) Filed: Jan. 30, 2024

(30) Foreign Application Priority Data
Dec. 18, 2023 (IN) 202311086506

(51) Int. Cl. G06F 11/00; G06F 11/30; G06F 11/34

(52) U.S. Cl. CPC G06F 11/008; G06F 11/3006; G06F 11/3409

(57) ABSTRACT

A system for predicting system component failures within a computer system that comprises a plurality of hardware components and a plurality of software components. The system may comprise memory storing instructions that, when executed, cause a processor to: obtain performance metrics by monitoring a network interface of the computer system; generate component failure probabilities by processing the performance metrics; determine that a first component failure probability among the component failure probabilities exceeds a risk threshold; determine remedial actions that mitigate a first component failure probability; and mitigate the first component failure probability by initiating an execution of the remedial actions.

### CROSS-REFERENCE TO RELATED APPLICATIONS

This application claims priority benefit from Indian Application No. 202311086506, filed Dec. 18, 2023, which is hereby incorporated by reference in its entirety.

### BACKGROUND

### 1. Field of the Invention

The field of the invention disclosed herein generally relates to a system for preventing the failure of components within a server and, more particularly, to a method, system, and computer-readable medium for implementing technology that proactively mitigates the failure of components within server hardware to improve the integrity of the server and, thereby, make its network more robust.

### 2. Background of the Invention

Datacenter and information technology networks have experienced exponential growth for several decades now, and most of the drivers for this growth arise from their scalability and lowered cost due to economies of scale. Datacenters provide computing infrastructure, house racks of servers, host a broad range of services for on-premise infrastructure platform architecture. The portfolio of most datacenters contains a large number of sites, which results in technology sprawl and inflated operating costs. In addition, such a portfolio is usually capacity-constrained and carries geographical concentration risk.

Server technology serves as the backbone to mission-critical applications and their support, so the availability of such technology is of underlaying importance to these highly sensitive applications. Therefore, in accordance with network administration best practices, data redundancy and datacenter mirroring techniques are often utilized to improve fault tolerance and ensure the availability of failover resources for added stability and the prevention of server outages. Hosting services enable separate customized resource configurations to be provided separately to multiple individual users (or tenants) while shifting the responsibility of building and maintaining the underlying hardware equipment for such services to the hosting technology's service provider.

Over the life of a server, operation downtimes can be triggered by downstream maintenance work, including system checks for determining whether hardware or software components (e.g., hard disk drives, memory modules, power supplies, rapid turnaround time (RTAT) and system boards) have failed, as well as the scheduling of the repair of such failures. However, this approach to maintaining a fleet of servers within a datacenter (i.e., a computer network) is expensive in terms of the total amount of time required for each maintenance action, which also translates to reduced capacity and service interruptions which, in turn, translates to financial losses and even a loss of goodwill.

Accordingly, there is a need in the field of the herein-disclosed invention for a technical solution to the foregoing limitations in the technology of existing approaches to maintaining a fleet of servers across multi-site/region datacenters.

### SUMMARY

The present disclosure, through one or more of its various aspects, embodiments, and/or specific features or sub-component, provides, inter alia, various systems, servers, devices, methods, media, programs and platforms for preventing the failure of components within a computer system to improve the computer system's integrity and make the computer system more robust.

According to an aspect of the present disclosure, a method is provided for predicting system component failures within a computer system that may comprise a plurality of hardware components and a plurality of software components. The method may comprise: obtaining a first set of performance metrics by monitoring a network interface of the computer system; generating a first set of component failure probabilities by processing the first set of performance metrics; determining that at least a first component failure probability from among the first set of component failure probabilities exceeds at least one risk threshold; determining a first set of remedial actions that mitigate at least a first component failure probability; and mitigating at least the first component failure probability by initiating an execution of the first set of remedial actions.

In the method, the obtaining may comprise periodically obtaining each of a plurality of sets of performance metrics that include the first set of performance metrics.

In the method, the network interface may comprise a connection to at least one from among a network feed and a network performance metric repository that stores a plurality of sets of historical performance metrics.

In the method, the first set of performance metrics may comprise at least one from among telemetry data, static system component data, network event data, and historical performance metrics. In the method, the system component data may comprise a set of system logs.

In the method, the processing may comprise cleansing the first set of performance metrics to produce a first set of cleansed performance metrics and generating the first set of component failure probabilities by evaluating the first set of cleansed performance metrics against a training dataset, and the training dataset may be based on historical performance metrics.

In the method, the training dataset may comprise a plurality of sets of performance metrics values, and each set of performance metrics values from among the plurality of sets of performance metrics values may respectively correlate to at least one type of corresponding component failure.

In the method, the processing may comprise performing the processing by utilizing a first artificial intelligence and machine learning (AI/ML) model that is trained to determine at least one component failure probability.

In the method, the processing may further comprise generating, by the first AI/ML model, the first set of component failure probabilities by evaluating the first set of performance metrics against a training dataset. Historical performance metrics may have been utilized to train the first AI/ML model to generate system component failure probabilities.

In the method, the first AI/ML model may determine the at least one component failure probability based on a respective degree of correspondence between the first set of performance metrics and at least one from among a plurality of sets of computer system performance metrics values. Each system component failure from among a first set of system component failures may have a respective correspondence that exceeds a respective correspondence threshold of the respective system component failure, and each system component failure from among the first set of system component failures may respectively correspond to at least one respective set of computer system performance metrics values from among the at least one of the plurality of sets of computer system performance metrics values. Moreover, the correspondence threshold may comprise one or more dynamic thresholds that may adjust according to changes in at least one from among the static system component data and the historical performance metrics, for example, the historical performance metrics may include a false-positive prediction metric and a false-negative prediction metric and to optimize (and/or reduce) one or more component costs, the dynamic threshold may be adjusted to reduce the false-positive prediction metric and/or the false-negative prediction metric.

In the method, at least one from among the first set of performance metrics may comprise first system component failure event data. Additionally, in the method, at least one system component failure from among a first set of system component failures may comprise a cascading failure. Furthermore, the cascading failure may result from a first system component failure that corresponds to a first system component failure.

According to another aspect of the present disclosure, a system is provided for predicting system component failures within a computer system that comprises a plurality of hardware components and a plurality of software components. The system may comprise a processor and memory that stores instructions that, when executed by the processor, cause the processor to perform operations. The operations may comprise: obtaining a first set of performance metrics by monitoring the network interface; generating a first set of component failure probabilities by processing the first set of performance metrics; determining that at least a first component failure probability from among the first set of component failure probabilities exceeds at least one risk threshold; determining a first set of remedial actions that mitigate at least a first component failure probability; and mitigating at least the first component failure probability by initiating an execution of the first set of remedial actions.

In the system, when the instructions are executed by the processor, the obtaining may comprise periodically obtaining each of a plurality of sets of performance metrics that include the first set of performance metrics.

In the system, the network interface comprises a connection to at least one from among a network feed and a network performance metric repository that stores a plurality of sets of historical performance metrics.

In the system, the first set of performance metrics comprises at least one from among telemetry data, static system component data, network event data, and historical performance metrics. In the system, the system component data may comprise a set of system logs.

In the system, when the instructions are executed by the processor, the processing may comprise cleansing the first set of performance metrics to produce a first set of cleansed performance metrics and generating the first set of component failure probabilities by evaluating the first set of cleansed performance metrics against a training dataset, and the training dataset may be based on historical performance metrics.

In the system, when the instructions cause the processor to perform the operations, the training dataset may comprise a plurality of sets of performance metrics values, and each set of performance metrics values from among the plurality of sets of performance metrics values may respectively correlate to at least one type of corresponding component failure.

In the system, when the instructions are executed by the processor, the processing may comprise performing the processing by utilizing a first artificial intelligence and machine learning (AI/ML) model that is trained to determine at least one component failure probability.

In the system, when the instructions are executed by the processor, the processing may further comprise generating, by the first AI/ML model, the first set of component failure probabilities by evaluating the first set of performance metrics against a training dataset. Historical performance metrics may have been utilized to train the first AI/ML model to generate system component failure probabilities.

In the system, when the instructions are executed by the processor, the first AI/ML model may determine the at least one component failure probability based on a respective degree of correspondence between the first set of performance metrics and at least one from among a plurality of sets of computer system performance metrics values. Each system component failure from among a first set of system component failures may have a respective correspondence that exceeds a correspondence threshold, and each system component failure from among the first set of system component failures may respectively correspond to at least one respective set of computer system performance metrics values from among the at least one of the plurality of sets of computer system performance metrics values. Moreover, the correspondence threshold may comprise one or more dynamic thresholds that may adjust according to changes in at least one from among the static system component data and the historical performance metrics, for example, the historical performance metrics may include a false-positive prediction metric and a false-negative prediction metric and to optimize (and/or reduce) one or more component costs, the processor may adjust the dynamic threshold to reduce the false-positive prediction metric and/or the false-negative prediction metric.

In the system, at least one from among the first set of performance metrics may comprise first system component failure event data. Additionally, in the system, at least one system component failure from among a first set of system component failures may comprise a cascading failure. Furthermore, in the system, the cascading failure may result from a first system component failure that corresponds to a first system component failure.

According to yet another aspect of the present disclosure, a non-transitory computer-readable medium is provided for predicting system component failures within a computer system that comprises a plurality of hardware components and a plurality of software components. The computer-readable medium may store instructions that, when executed by a processor, cause the processor to perform operations. The operations may comprise: obtaining a first set of performance metrics by monitoring a network interface of the computer system; generating a first set of component failure probabilities by processing the first set of performance metrics; determining that at least a first component failure probability from among the first set of component failure probabilities exceeds at least one risk threshold; determining a first set of remedial actions that mitigate at least a first component failure probability; and mitigating at least the first component failure probability by initiating an execution of the first set of remedial actions.

In the computer-readable medium, when the instructions are executed by the processor, the obtaining may comprise periodically obtaining each of a plurality of sets of performance metrics that include the first set of performance metrics.

In the computer-readable medium, the network interface may comprise a connection to at least one from among a network feed and a network performance metric repository that stores a plurality of sets of historical performance metrics.

In the computer-readable medium, the first set of performance metrics may comprise at least one from among telemetry data, static system component data, network event data, and historical performance metrics. In the computer-readable medium, the system component data may comprise a set of system logs.

In the computer-readable medium, when the instructions are executed by the processor, the processing may comprise cleansing the first set of performance metrics to produce a first set of cleansed performance metrics and generating the first set of component failure probabilities by evaluating the first set of cleansed performance metrics against a training dataset, and the training dataset may be based on historical performance metrics.

In the computer-readable medium, the training dataset may comprise a plurality of sets of performance metrics values, and each set of performance metrics values from among the plurality of sets of performance metrics values may respectively correlate to at least one type of corresponding component failure.

In the computer-readable medium, when the instructions are executed by the processor, the processing may comprise performing the processing by utilizing a first artificial intelligence and machine learning (AI/ML) model that is trained to determine at least one component failure probability.

In the computer-readable medium, when the instructions are executed by the processor, the processing may further comprise generating, by the first AI/ML model, the first set of component failure probabilities by evaluating the first set of performance metrics against a training dataset. Historical performance metrics may have been utilized to train the first AI/ML model to generate system component failure probabilities.

In the computer-readable medium, when the instructions are executed by the processor, the first AI/ML model may determine the at least one component failure probability based on a respective degree of correspondence between the first set of performance metrics and at least one from among a plurality of sets of computer system performance metrics values. Each system component failure from among a first set of system component failures may have a respective correspondence that exceeds a correspondence threshold, and each system component failure from among the first set of system component failures may respectively correspond to at least one respective set of computer system performance metrics values from among the at least one of the plurality of sets of computer system performance metrics values. Moreover, the correspondence threshold may comprise one or more dynamic thresholds that may adjust according to changes in at least one from among the static system component data and the historical performance metrics, for example, the historical performance metrics may include a false-positive prediction metric and a false-negative prediction metric and to optimize (and/or reduce) one or more component costs, the operations may further comprise adjusting the dynamic threshold to reduce the false-positive prediction metric and/or the false-negative prediction metric.

In the computer-readable medium, at least one from among the first set of performance metrics may comprise first system component failure event data. Additionally, in the computer-readable medium, at least one system component failure from among a first set of system component failures may comprise a cascading failure. Furthermore, the cascading failure may result from a first system component failure that corresponds to a first system component failure.

Thereby, the invention disclosed herein improves the integrity of existing computer technology, thus making such technology more robust, by preventing the failure of components within a computer system.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 is a diagram of an exemplary computer system.

FIG. 2 is a diagram of an exemplary network environment for a failure prediction tool that prevents the failure of components within a computer network.

FIG. 3 is a diagram of an exemplary perspective of a network environment that utilizes a failure prediction tool to prevent the failure of components within a computer network.

FIG. 4 is a flowchart of an exemplary process for preventing the failure of components within a computer system.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer-readable media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

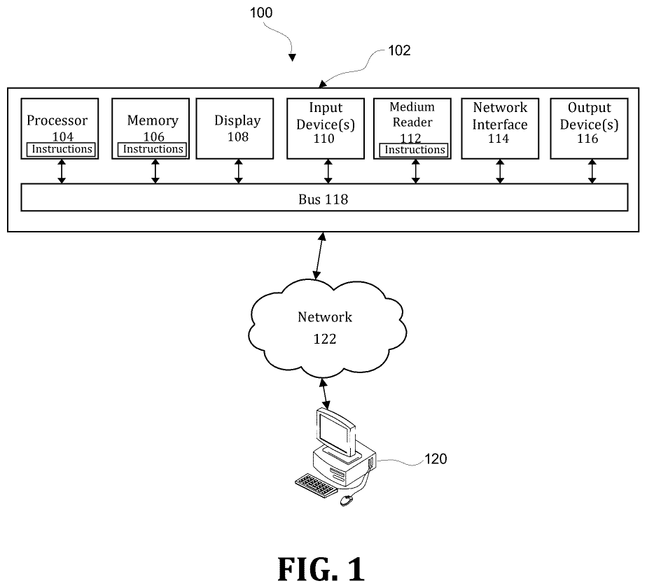

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing a failure prediction tool that manages access to resources of a network.

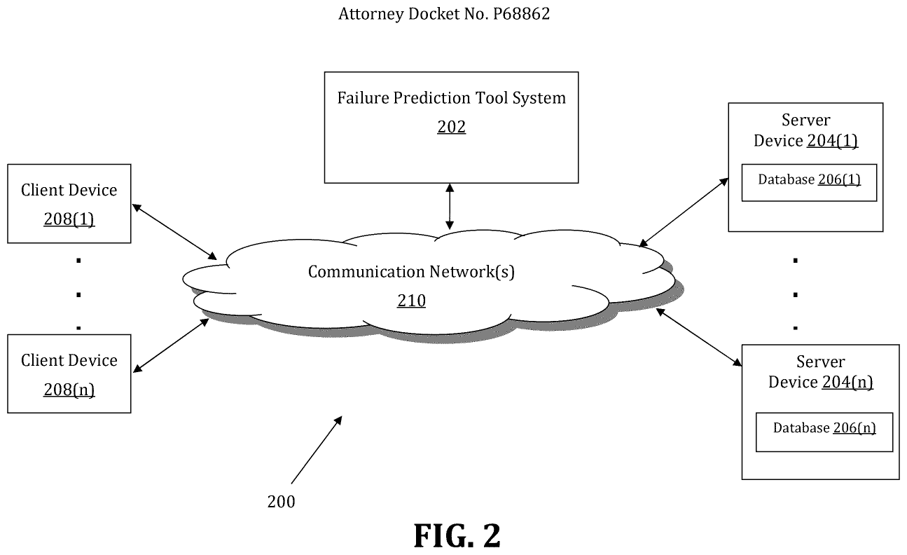

Referring to FIG. 2, a schematic of an exemplary network environment 200 for a failure prediction tool that prevents the failure of components within a computer network, is illustrated. In an exemplary embodiment, a failure prediction tool may be implemented on any networked computer platform, such as, for example, a personal computer (PC).

A method for implementing technology for preventing the failure of components within a computer system may be implemented by a Failure Prediction Tool (FPT) device 202. The FPT system 202 may be the same or similar to the computer system 102 as described with respect to FIG. 1. The FPT system 202 may be a rack-mounted server in a datacenter, an embedded microcontroller (MCU) in an electronic device, or another type of headless system, which is a computer system or device that is configured to operate without a monitor, keyboard and mouse. The FPT system 202 may store one or more applications that can include executable instructions that, when executed by the FPT system 202, cause the FPT system 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the FPT system 202 itself, may be located in virtual server(s) running in a cloud-based computing environment rather than being tied to one or more specific physical network computing devices. Also, the application(s) may be running in one or more virtual machines (VMs) executing on the FPT system 202. Additionally, in one or more embodiments of this technology, virtual machine(s) running on the FPT system 202 may be managed or supervised by a hypervisor.

In the network environment 200 of FIG. 2, the FPT system 202 is coupled to a plurality of server devices 204(1)-204(n) that hosts a plurality of databases 206(1)-206(n), and also to a plurality of client devices 208(1)-208(n) via communication network(s) 210. A communication interface of the FPT system 202, such as the network interface 114 of the computer system 102 of FIG. 1, operatively couples and communicates between the FPT system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the FPT system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, computer-readable media, and FPT system that efficiently implement a method for a failure prediction tool that improves the overall speed, ease, and user experience of cyber defense capability assessment tasks.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The FPT system 202 may be a standalone device or integrated with one or more other devices or apparatuses, such as one or more of the server devices 204(1)-204(n), for example. In one particular example, the FPT system 202 may include or be hosted by one of the server devices 204(1)-204(n), and other arrangements are also possible. As another example, the FPT system 202 may be integrated with one or more other devices or apparatuses, such as one or more of the client devices 208(1)-208(n). Moreover, one or more of the devices of the FPT system 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the FPT system 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to a variety of databases.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the FPT system 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the FPT system 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the FPT system 202, the server devices 204(1)-204(n), the databases 206(1)-206(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the FPT system 202, the server devices 204(1)-204(n), the databases 206(1)-206(n), or the client devices 208(1)-208(n), for example, may be configured to operate as virtual instances on the same physical machine. In other words, one or more of the FPT system 202, the server devices 204(1)-204(n), the databases 206(1)-206(n), or the client devices 208(1)-208(n) may operate on the same physical device rather than as separate devices communicating through communication network(s) 210. Additionally, there may be more or fewer FPT systems 202, server devices 204(1)-204(n), databases 206(1)-206(n), or client devices 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

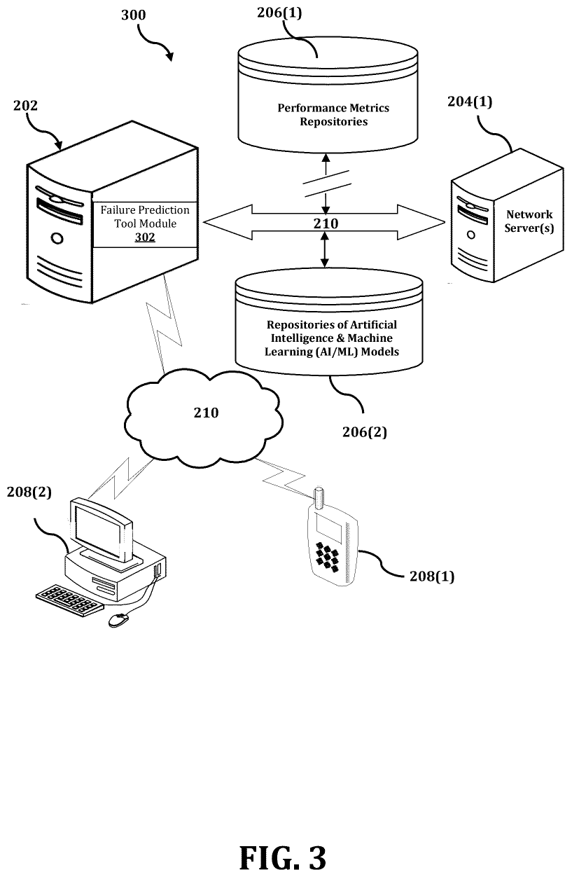

The FPT system 202 is described and illustrated in FIG. 3 as including failure prediction tool module 302, although it may include other rules, policies, modules, databases, or applications, for example. As will be described below, failure prediction tool module 302 is configured to prevent the failure of components within a computer system, failure prediction tool module 302 may include software that is based on a microservices architecture.

failure prediction tool module 302 may be integrated with one or more devices or apparatuses, such as client devices 208(1)-208(n), where failure prediction tool module 302 may be implemented as an application or as an addon or plugin to another application of the one or more devices or apparatuses, and where failure prediction tool module 302 may execute in the background.

An exemplary process 300 for application of a failure prediction tool to an aspect of the network environment of FIG. 2 is illustrated as being executed in FIG. 3. Specifically, a first client device 208(1) and a second client device 208(2) are illustrated as being in communication with FPT system 202. In this regard, the first client device 208(1) and the second client device 208(2) may be “clients” of the FPT system 202 and are described herein as such. Nevertheless, it is to be known and understood that the first client device 208(1) and/or the second client device 208(2) need not necessarily be “clients” of the FPT system 202, or any entity described in association therewith herein. Any additional or alternative relationship may exist between either or both of first client device 208(1), second client device 208(2) and FPT system 202, or no relationship may exist.

Further, FPT system 202 is illustrated as being able to access performance metrics repositories 206(1), and repositories of artificial intelligence and machine learning (AI/ML) models 206(2). FPT system 202 may comprise a failure prediction tool that communicates with performance metrics repositories 206(1). In addition, the failure prediction tool of FPT system 202 may also communicate with repositories of AI/ML models 206(2). The failure prediction tool module 302 may be configured to access these databases in order to evaluate how a client's values align with environmental, social, and/or governance (ESG) information pertaining to one or more businesses.

Moreover, FPT system 202 may receive and transmit data via communication network(s) 210. FPT system 202 may receive and transmit data such as code that is written in one or more of the following dialects: transaction control language (TCL), data manipulation language (DML), data control language (DCL) and data definition language (DFL). Additionally, via communication network(s) 210, FPT system 202 may respectively receive and transmit data from and to one or more of the following devices: network server(s) 204(1), performance metrics repositories 206(1), repositories of AI/ML models 206(2), first client device 208(1), the second client device 208(2), and communication network(s) 210, for example.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The client devices 208(1)-208(n) may represent, for example, computer systems of an organization or database network. The first client device 208(1) represent, for example, one or more computer systems of a department or cluster within the organization or database network. Of course, the first client device 208(1) may include one or more of any of the devices described herein. The second client device 208(2) may be, for example, one or more computer systems of another department or cluster within the organization or database network. Of course, the second client device 208(2) may include one or more of any of the devices described herein.

The process may be executed via the communication network(s) 210, which may comprise plural networks as described above. For example, in an exemplary embodiment, either the first client device 208(1), the second client device 208(2), or both may communicate with the FPT system 202 via broadband or cellular communication. Of course, these embodiments are merely exemplary and are not limiting or exhaustive.

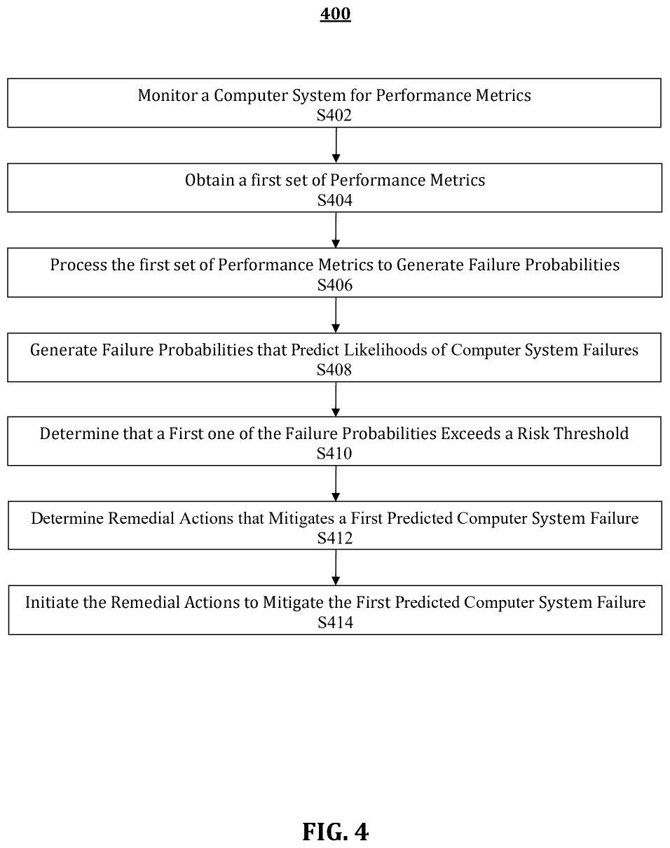

Failure prediction tool module 302 may execute a process for preventing the failure of components within a network. An exemplary process for preventing the failure of components within a network is generally indicated at flowchart 400 in FIG. 4.

In process 400 of FIG. 4, at step S402, failure prediction tool module 302 monitors a computer system in order to obtain its performance metrics. The computer system may comprise the infrastructure of any electronic network such as communication network(s) 210 and/or, in an embodiment, bus 118. At step S402, failure prediction tool module 302 may monitor the computer system via one or more network interface(s) of the computer system. These network interfaces may include any software and/or hardware interface, such as network interface 114.

In an exemplary embodiment, these network interfaces may further include at least one connection (physical or otherwise) to at least one network data feed of one or more streams of performance metrics that pertain to the computer system. For the purposes of the invention disclosed herein, performance metrics may include (but is not limited to) one or more from among log data, telemetry data, static network component data, network event data, and historical performance metrics, and historical performance metrics may include (but is not limited to) one or more from among historical log data, historical telemetry data, historical static network component data, and historical network event data.

Static network component data may comprise data such as a network component's make, model, manufacturer, datacenter region, country code, location, product class, date of manufacture, operating capacities (e.g., size, speed, etc.), and other specifications of the network component. Static network component data is typically set during a network component's initial setup and may change infrequently or may not change at all. Static network component data may provide baseline information about the component within a network, such as the computer system. In an embodiment, the network component may be a system component, such as a hardware component of a server computer system, for example.

Network event data may comprise network component lifecycle events such as firmware and/or software upgrades and network component failure data. In addition, network event data may comprise information about a history of one or more chained network component cascading failure(s) and their correlation(s) to future network component failures. Historical performance metrics may comprise one or more from among historical telemetry data, historical static network component data, and historical network event data. In an embodiment, historical performance metrics may comprise data (e.g., date and/or time of failure, date and/or time of reporting, date and/or time of resolution, location and itemization of failed components, etc.) that pertains to network component failures across all the components of a network such as the computer system.

At step S404, failure prediction tool module 302 obtains a first set of performance metrics due to the monitoring at step S402. At step S404, the first set of performance metrics may be obtained by failure prediction tool module 302 itself or by failure prediction tool module 302's receipt of the first set of performance metrics from one or more sources. In an exemplary embodiment, S404 may be performed throughout the duration of step S402. In a further embodiment, step S404 may be performed periodically throughout the duration of step S402. In yet an even further embodiment, the frequency at which step S404 is performed may depend on the type of performance metrics that that are being obtained.

In an exemplary embodiment, a REST API Connector may be used to periodically fetch data from multiple endpoints (e.g., Redfish endpoints) for each server respectively (e.g., network server(s) 204(1)), and data may be published to a database (e.g., performance metrics repositories 206(1)) by utilizing a sink (e.g., a Kafka sink). Redfish refers to a suite of specifications that deliver an industry standard protocol and provides a RESTful interface for the management of servers, storage, networking, and converged infrastructure. Redfish is a DMTF (Distributed Management Task Force) standard that defines a standardized API ensuring consistency and interoperability across different vendors/manufacturers and components.

In an additional or alternate embodiment, telemetry agents may retrieve Redfish readings, such as thermal, power and fan data etc., to obtain the first set of performance metrics. Failure prediction tool module 302 may utilize Redfish to standardize its live data collection across vendors and make use of an established, safe route to systematically implement mass data collection regiments because Redfish may maintains autonomy from third-party plugins, which mitigates a risk of introducing malware to failure prediction tool module 302 and/or a network such as the computer system. In the embodiment, the historical performance metrics may include telemetry data that has been obtained from a measurement of an instrument that has measured at least one from among the historical performance metrics. However, in the embodiment, the historical performance metrics may additionally (or alternatively) include data that has not been obtained from a measurement of an instrument that has measured at least one from among the historical performance metrics.

In the exemplary embodiment, telemetry data may be the performance metrics type that is obtained the most frequently (e.g., every microsecond, millisecond, hundredth of a second, tenth of a second, second, minute, fifteen minutes, hour, etc.), while obtaining static system component data and network event data may be obtained less frequently (e.g., limited to instances when a change is made to a system component and instances when there is a network event, e.g., a network failure event, respectively) than the telemetry data, and obtaining historical performance metrics may only be obtained when it is required for evaluation against or comparison to an obtained set of performance metrics (e.g., the first set of performance metrics). In a further embodiment, obtaining static system component data and network event data may be performed periodically (e.g., every minute, fifteen minutes, hour, 12 hours, day, other day, week, etc.) as well as whenever a change is made to a system component or whenever there is a network event (e.g., a network failure event), respectively.

At step S406, failure prediction tool module 302 processes the first set of performance metrics to generate a first set of component failure probabilities. At step S406, failure prediction tool module 302 may process the first set of performance metrics by, first, producing (or generating) a first set of cleansed performance metrics by cleansing the first set of performance metrics. Subsequently, at step S406 failure prediction tool module 302 may then evaluate the first set of cleansed performance metrics against a training dataset in order to generate a first set of component failure probabilities, which may comprise one or more probabilities (or likelihoods) that one or more distinct failures of any of the computer system's components may occur.

In an embodiment, the training dataset may be based on historical performance metrics, which may be stored in one or more repositories such as performance metrics repositories 206(1). In an exemplary embodiment, the training dataset may be based on historical failure data. In an additional or alternative embodiment, the training dataset may comprise a plurality of sets of performance metrics values, and each set of performance metrics values from among the plurality of sets of performance metrics values may respectively correlate to at least one type of corresponding component failure.

In the embodiment, the taxonomy may facilitate the search, discovery and navigation of large volumes of information, thereby improving the identification of system component failures, which may be critical for a system's efficiency. The different principal ranks of system component failures may allow for distinct protocols to be activated, engaged and employed in their categories, thereby allowing for distinct downstream treatments to be performed based on a type of component failure that is predicted.

At step S406, failure prediction tool module 302 may process the first set of performance metrics by, first, cleansing the first set of performance metrics to produce a first set of cleansed performance metrics, then generating the first set of component failure probabilities by evaluating the first set of cleansed performance metrics against the training dataset. In an embodiment, cleansing the first set of performance metrics may comprise one or more from among removing redundancies, removing irrelevant data, removing corrupt data, removing incorrect data, repairing corrupt data, and correcting incorrect data.

In an embodiment, data for distinct database tables may be cleaned and transformed individually, then merged in a manner where each row of data provides a snapshot of a state of a system component at a particular point in time, where the provided snapshot may utilize an associated value that corresponds to each feature. In other words, the first set of performance metrics may be processed by concatenating the performance metrics to obtain sets of component failure probabilities. For each hardware component, the time-ordered data is retrieved. Starting with a latest time, feature matrices may be generated based on a predetermined duration of time and periods of time between different predetermined durations. Each feature matrix may be designated as either negative or positive. Positive feature matrices may be feature matrices that are generated closest to a system component failure event and may be based on a predetermined number of positive feature matrices to be derived for each system component failure event. On the other hand, negative feature matrices may simply refer to matrices that are not positive feature matrices. Inference data may be prepared similarly to the training dataset (e.g., historical performance matrices) and (possibly) without the association of labels.

The first set of component failure probabilities generated at step S406, may include at least one system component failure probability, and each of the at least one system component failure probability may be individually based on a respective degree of correspondence between the first set of performance metrics and at least one performance metrics marker that serves as a predicate for at least one failure of a component within a network such as the computer system. In an exemplary embodiment, one or more of the at least one performance metrics marker may comprise a set of performance metrics values from among the plurality of sets of performance metrics values.

In an embodiment, one of the at least one performance metrics marker may comprise a system component failure event, and the at least one system component failure probability pertains to a cascading failure. In the embodiment, a cascading failure may describe failures in which multiple and successive system component failures occur due to some dependency on a preceding system component failure. For example, the initial failure of a system component may cause a plurality of other system components to fail over time in a chain-like reaction within a server or related servers.

Cascading failures typically take place when system components have some dependency that may be traced back to a preceding system component failure, and these failures often occur when a critical hardware component, such as a power supply unit, fails in a single server or in a particular area (such as a rack) of the data center. Subsequently, this failure may cause a surge in power demand from other servers located within the same rack, which may have the potential to overload the uninterruptible power supply (UPS) or power distribution unit (PDU) that distributes power to that rack, leading to other severs in the rack to be unstable or shut down, further inducing the cycle. Similarly, the failure of a cooling system may cause servers to overheat, which may lead to performance degradation and hardware damage. Indeed, the temperature in the data center may even rise to dangerous levels and shutdown one or more of the affected servers entirely.

The initial failure in a chain of cascading failures may occur for any of a variety of reasons, such as a random failure for example. However, a cascading failure is a failure in a system of interconnected system components where the failure of one or a few system components leads to the failure of other system components, the probability of which may grow exponentially due to the increased load that may be placed on other system components to compensate for the failover load(s) of those components that have failed, which may ultimately lead to a total failure. This chain of failure process may cascade through the system components of a server and continues until substantially all its components are compromised, and the server fails completely. Cascading failures differ from other types of component failures because cascading failures require a separation of time between their initial failure and the system component failure(s) that subsequently result(s) from that initial failure since these are not simultaneous events. However, in an embodiment, cascading failures may be limited to failures that fall within a specified interval of time and, thereby, cascading failures may exclude failures from a chain of failures if they do not fall within that specified interval of time.

In an embodiment, at step S406, failure prediction tool module 302 may utilize an artificial intelligence and machine learning (AI/ML) model to process the first set of performance metrics. In the embodiment, the static system component data may be utilized as the AI/ML model's feature attributes, which describe characteristics/properties of the system component. In a further embodiment, historical performance metrics may have been utilized to train the AI/ML model to identify performance metrics markers that serve as a predicate for at least one failure of a component within a network such as the computer system.

In yet an even further embodiment, the AI/ML model may process the first set of performance metrics by evaluating the first set of performance metrics, and the AI/ML model may generate the first set of component failure probabilities from that evaluation of the first set of performance metrics. In an embodiment, the training of AI/ML model may identify (and thus subsequently evaluate one or more sets of performance metrics against) one or more performance metrics markers (or one or more sets of performance metrics values) that serve as one or more predicates for at least one from among an unknown bug, an unknown defect and an unknown error that may be one or more from among component-specific, product-specific, make-specific, model-specific, version-specific, lot-specific, configuration-specific, manufacturer-specific, and otherwise. It should be noted that each herein-disclosed AI/ML model may be stored within, and retrieved (e.g., by failure prediction tool module 302) from, a repository such as repositories of AI/ML models 206(2).

It should also be noted that a step to detect an occurrence of data drift and/or concept drift, is embedded within the machine learning pipeline. Data drift may occur when a distribution of the features for a particular system component changes, and concept drift occurs when statistical properties of a cascading failure (or its marker) changes. In an embodiment, detecting a data drift and/or concept drift may trigger a re-training of one or more existing AI/ML models that pertain to such drift, because these drifts invalidate the existing AI/ML models. In a further embodiment, the one or more existing AI/ML models may be re-trained with an updated dataset (e.g., updated historic performance metrics data) in a similar or substantially the same manner as the above-mentioned AI/ML model.

In an embodiment, the AI/ML model may utilize either a supervised and/or an unsupervised machine learning model to perform predictive analytics. A supervised machine learning model may include Random Forest, Decision Tree, Logistic Regression, K-nearest Neighbours, Stacking Classifiers, Recurrent Autoencoder with a classification layer and Transformer with a classification layer. Generally, supervised learning machine learning models may take matrices or a transformed form of the matrices as training input, and labels as training output. Unsupervised machine learning models may include One-Class Support Vector Machine and Isolation Forest. Unsupervised machine learning models may take a transformed form of only positive labelled matrices as input.

At step S408, failure prediction tool module 302 generates the first set of component failure probabilities. In an embodiment, each individual component failure probability of the first set of component failure probabilities may comprise its own distinct value that represents a respective degree of correspondence between the first set of performance metrics and at least one from among a plurality of performance metrics markers (i.e., at least one from among a plurality of sets of performance metrics values).

In an exemplary embodiment of process 400, failure prediction tool module 302 may perform step S408 by evaluating the first set of performance metrics against a dictionary (e.g., a taxonomy) of types of component failures. In an additional or alternative exemplary embodiment, failure prediction tool module 302 may also perform step S408 by evaluating the first set of performance metrics against one or more from among: static component data, coupled component failure probability data, and any other data that identifies one or more precursors (e.g., forerunning conditions) to at least one component failure type. Additionally, or alternatively, failure prediction tool module 302 may then evaluate the first set of component failure probabilities against a set of classification rules to determine which from among the at least one component failure type, each component failure probability (from among the first set of component probabilities) pertains.

As indicated above, in an embodiment, at step S408, failure prediction tool module 302 may utilize the AI/ML model to generate the first set of component failure probabilities. In an embodiment, the AI/ML model may comprise one or more distinct AI/ML models that are at least one from among component-specific, product-specific, make-specific, model-specific, version-specific, lot-specific, configuration-specific, manufacturer-specific, and otherwise.

In the embodiment, a particular product-specific (or other type-specific) AI/ML model that may be utilized to perform the above-mentioned evaluation may be based on the particular type (e.g., product, make, model, version, lot, configuration, manufacturer, etc.) of system component or particular component (e.g., device or software instance) to which the first set of performance metrics pertains. In this embodiment, the particular type of system component or particular component to which the first set of performance metrics pertains may be either determined or obtained (and potentially verified) during step S406 but after the cleansing of the first set of performance metrics data, and prior to the evaluation of the first set of cleansed data.

After step S408, failure prediction tool module 302 determines whether any of the first set of component failure probabilities exceeds a respective one or more risk thresholds that indicates whether a probability of a component failure possess such a significant risk to the computer system that at least one remedial action should be taken to mitigate such predicted failure. Then, at step S410, failure prediction tool module 302 actually determines that each of one or more failure probabilities from among the first set of component failure probabilities exceeds a respective one or more risk thresholds that indicates whether a probability of a component failure possess such a significant risk to the computer system that at least one remedial action should be taken to mitigate such predicted failure. In an embodiment, each of the one or more risk thresholds may be distinct and one or more from among component-specific, product-specific, make-specific, model-specific, version-specific, lot-specific, configuration-specific, manufacturer-specific, and otherwise.

Type-specific risk thresholds may be based on the particular type (e.g., product, make, model, version, lot, configuration, manufacturer, etc.) of system component or particular component (e.g., device or software instance) to which the first set of performance metrics pertains. As previously mentioned with regards to type-specific AI/ML models, the particular type of system component or particular component to which the first set of performance metrics pertains may be either determined or obtained (and potentially verified) during step S406 but after the cleansing of the first set of performance metrics data, and prior to the evaluation of the first set of cleansed data.

It should be noted that, in an alternative process, after step S408, failure prediction tool module 302 may instead determine that none of the one or more failure probabilities from among the first set of component failure probabilities exceeds the respective one or more risk thresholds that indicates whether the at least one remedial action should be taken to mitigate a predicted failure. Accordingly, after step S408, such a process may either terminate or be repeated by returning to step S402 until a failure is predicted or for a predetermined duration of time (or for a predetermined number of times). However, at some point in this alternative process, failure prediction tool module 302 may return to process 400 by performing step S410 (i.e., determining that each of the one or more failure probabilities from among the first set of component failure probabilities exceeds the respective one or more risk thresholds). Returning to process 400, after step S410, failure prediction tool module 302 then performs steps S412 and S414.

At step S412, failure prediction tool module 302 determines at least one remedial action that mitigates one or more respective predicted computer system component failures that each distinctly corresponds to the one or more failure probabilities from among the first set of component failure probabilities that exceeds the respective one or more risk thresholds. At step S414, failure prediction tool module 302 initiates the at least one remedial action to mitigate the one or more respective predicted computer system component failures. After step S414, process 400 may return to step S402 in order for failure prediction tool module 302 to perform process 400 for a second set of performance metrics. In an additional or alternative embodiment, process 400 may end (or terminate) after step S414. In a further embodiment, after step S414, process 400 may return to step S402 either indefinitely or return to step S402 until a predetermined time or a predetermined amount performance metrics data has been monitored or processed.

In addition to the foregoing, predictive analytics for cascading failures may be displayed in a user interface of failure prediction tool module 302, where users may view such analytics from a user interface. In this embodiment, the user interface may display prediction results and relative confidence scores (e.g., the first set of component failure probabilities) of failures such as cascading failures in the near future for each system component across all components of a network (such as the computer system) for each AI/ML model respectively. Accordingly, failure prediction tool module 302 thereby gives a maintenance team the ability to filter and sort through all its available data to determine an appropriate course of action. The most likely components to fail in the near future, which may be determined according to a majority voting mechanism across all AI/ML models, may be further emphasized and flagged out to the team through a view in the interface. This may suggest where a concerted effort should be placed, forming the highest priority cluster to address and rectify potential hardware component problems from occurring and developing, which may stop or halt the development of further system component problems arising from the particular system component and may provide potential cost savings by proactively mitigating one or more predicted system component failures.

In an embodiment, the above-mentioned interface may include a cumulative analysis view that provides trend data of summed cascading failure counts for each type of system component, and may also include component insight views and provide data on a percentage that system components contribute to one or more failures and provide incident counts along with other data cuts such as region-based data. Cumulatively, these views may provide critical insights into whether data across a slice (such as region) historically has a high number of cascading failures when cut across certain values that requires targeted mitigation efforts. Failure prediction tool module 302 utilizes analytics pertaining to a history of system component failures and plays a key role in retrospective decisions to select system component (e.g., server) models that should be Invest-rated by comparing system component consistency and reliability metrics.

Moreover, in the context of cascading failures, failure prediction tool module 302 may identify a root cause of a failure by determining which system component failed first, and how that failure may have propagated to other system components. Based on the identified root cause, failure prediction tool module 302 may then suggest remediation actions based on a predicted pattern of failures, one such remedial action may include shutting down non-critical system components in order to prevent further damage and/or to contain the damage by isolating the affected components and another such remedial action may include replacing one or more components that are linked to each system component that is subject to a predicted cascading failure.

Failure prediction tool module 302 may deem a predicted system component failure as either reparable (i.e., not requiring a replacement) or non-reparable (i.e., requiring a replacement). In an embodiment, failure prediction tool module 302 may have access to a component stock count that can be utilized to determine whether a replacement component is in stock or whether failure prediction tool module 302 should be triggered to place an order for the replacement component. Failure prediction tool module 302 may monitor new (and/or replacement) system components (e.g., Disk, DIMM, etc.) stock levels of each datacenter location and failure prediction tool module 302 may trigger an automated ordering of a specific system component type for a component (e.g., a server model) to build up stock availability in case an event arises where a system component needs to be replaced. Failure prediction tool module 302 may then suggest manpower personnel allocation across a time period based on a specified hardware component's current stock levels which indicate system component replacements that can be addressed and based on an estimated delivery date and/or time of ordered system components, which may indicate that such a system component's replacement may be addressed later. Such automated downstream actions saves time and minimizes outages and downtime.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for predicting system component failures within a computer system, the method comprising:
obtaining a first set of performance metrics by monitoring a network interface of the computer system;
generating a first set of component failure probabilities by processing the first set of performance metrics;
determining that at least a first component failure probability from among the first set of component failure probabilities exceeds at least one risk threshold;
determining a first set of remedial actions that mitigate at least a first component failure probability; and
mitigating at least the first component failure probability by initiating an execution of the first set of remedial actions.

2. The method of claim 1, wherein the obtaining comprises:
periodically obtaining each of a plurality of sets of performance metrics that include the first set of performance metrics.

3. The method of claim 1, wherein the network interface comprises a connection to at least one from among a network feed and a network performance metric repository that stores a plurality of sets of historical performance metrics.

4. The method of claim 1, wherein the first set of performance metrics comprises at least one from among telemetry data, static system component data, network event data, and historical performance metrics.

5. The method of claim 1, wherein the processing comprises:
cleansing the first set of performance metrics to produce a first set of cleansed performance metrics; and
generating the first set of component failure probabilities by evaluating the first set of cleansed performance metrics against a training dataset,
wherein the training dataset is based on historical performance metrics.

6. The method of claim 5,
wherein the training dataset comprises a plurality of sets of performance metrics values, and
wherein each set of performance metrics values from among the plurality of sets of performance metrics values respectively correlates to a cascading failure.

7. The method of claim 1, wherein the processing comprises:
performing the processing by utilizing a first artificial intelligence and machine learning (AI/ML) model that is trained to determine at least one component failure probability that is linked to a cascading failure.

8. The method of claim 7, wherein the processing further comprises:
generating, by the first AI/ML model, the first set of component failure probabilities by evaluating the first set of performance metrics against a trained model,
wherein historical performance metrics have been utilized to train the first AI/ML model to generate system component failure probabilities.

9. The method of claim 7,
wherein the first AI/ML model determines the at least one component failure probability based on a respective degree of correspondence between the first set of performance metrics and at least one from among a plurality of sets of computer system performance metrics values,
wherein each system component failure from among a first set of system component failures has a respective correspondence that exceeds a correspondence threshold, and
wherein each system component failure from among the first set of system component failures respectively corresponds to at least one respective set of computer system performance metrics values from among the at least one of the plurality of sets of computer system performance metrics values.

10. The method of claim 9,
wherein at least one from among the first set of performance metrics comprises first system component failure event data, and
wherein at least one system component failure from among a first set of system component failures comprises a cascading failure that results from a first system component failure that corresponds to a first system component failure.

11. A system for predicting system component failures within a computer system, the system comprising:
a processor;
a network interface of the computer system; and
memory storing instructions that, when executed by the processor, cause the processor to perform operations comprising:
obtaining a first set of performance metrics by monitoring the network interface;
generating a first set of component failure probabilities by processing the first set of performance metrics;
determining that at least a first component failure probability from among the first set of component failure probabilities exceeds at least one risk threshold;
determining a first set of remedial actions that mitigate at least a first component failure probability; and
mitigating at least the first component failure probability by initiating an execution of the first set of remedial actions.

12. The system of claim 11, wherein when the instructions are executed by the processor, the processing comprises:
cleansing the first set of performance metrics to produce a first set of cleansed performance metrics; and
generating the first set of component failure probabilities by evaluating the first set of cleansed performance metrics against a training dataset,
wherein the training dataset is based on historical performance metrics.

13. The system of claim 12,
wherein the training dataset comprises a plurality of sets of performance metrics values, and
wherein each set of performance metrics values from among the plurality of sets of performance metrics values respectively correlates to a cascading failure.

14. The system of claim 11, wherein when the instructions are executed by the processor, the processing comprises:
performing the processing by utilizing a first artificial intelligence and machine learning (AI/ML) model that is trained to determine at least one component failure probability that is linked to a cascading failure.

15. The system of claim 14, wherein when the instructions are executed by the processor, the processing further comprises:
generating, by the first AI/ML model, the first set of component failure probabilities by evaluating the first set of performance metrics against a trained model,
wherein historical performance metrics have been utilized to train the first AI/ML model to generate system component failure probabilities.

16. The system of claim 14, wherein when the instructions are executed by the processor,
the first AI/ML model determines the at least one component failure probability based on a respective degree of correspondence between the first set of performance metrics and at least one from among a plurality of sets of computer system performance metrics values,
wherein each system component failure from among a first set of system component failures has a respective correspondence that exceeds a correspondence threshold, and
wherein each system component failure from among the first set of system component failures respectively corresponds to at least one respective set of computer system performance metrics values from among the at least one of the plurality of sets of computer system performance metrics values.

17. The system of claim 16,
wherein at least one from among the first set of performance metrics comprises first system component failure event data, and
wherein at least one system component failure from among a first set of system component failures comprises a cascading failure that results from a first system component failure that corresponds to a first system component failure.

18. A non-transitory computer-readable medium for predicting system component failures within a computer system, the computer-readable medium storing instructions that, when executed by a processor, cause the processor to perform operations comprising:
obtaining a first set of performance metrics by monitoring a network interface of the computer system;
generating a first set of component failure probabilities by processing the first set of performance metrics;
determining that at least a first component failure probability from among the first set of component failure probabilities exceeds at least one risk threshold;
determining a first set of remedial actions that mitigate at least a first component failure probability; and
mitigating at least the first component failure probability by initiating an execution of the first set of remedial actions.

19. The computer-readable medium of claim 18, wherein when the instructions are executed by the processor, the processing comprises:
performing the processing by utilizing a first artificial intelligence and machine learning (AI/ML) model that is trained to generate the first set of component failure probabilities by evaluating the first set of performance metrics against a training dataset,
wherein the first AI/ML model determines the first set of component failure probabilities based on a respective set of degrees of correspondence between the first set of performance metrics and at least one from among a plurality of sets of computer system performance metrics values.

20. The computer-readable medium of claim 19,
wherein at least one from among the first set of performance metrics comprises first system component failure event data, and
wherein at least one system component failure from among a first set of system component failures comprises a cascading failure that results from a first system component failure that corresponds to a first system component failure.
